(19) United States
(12) Patent Application Publication
(10) Pub. No.: US 2013/0224561 A1
(43) Pub. Date: Aug. 29, 2013

(54) BRAZE COMPOSITIONS, AND RELATED ARTICLES AND METHODS

(71) Applicants: Raghavendra Rao Adharapurapu, Schenectady, NY (US); Sundeep Kumar, Bangalore (IN); Mohamed Rahmane, Ballston Lake, NY (US)

(72) Inventors: Raghavendra Rao Adharapurapu, Schenectady, NY (US); Sundeep Kumar, Bangalore (IN); Mohamed Rahmane, Ballston Lake, NY (US)

(73) Assignee: GENERAL ELECTRIC COMPANY, SCHENECTADY, NY (US)

(21) Appl. No.: 13/407,870

(22) Filed: Feb. 29, 2012

(51) Int. Cl. H01M 2/08; B23K 35/12; H01M 10/04; B23K 31/02; B23K 35/24; C22C 19/03; C22C 19/05

(52) U.S. Cl. 429/149; 420/441; 420/456; 420/457; 420/459; 420/442; 228/256; 228/246; 429/122

(57) ABSTRACT

A braze alloy composition for sealing a ceramic component to a metal component in an electrochemical cell is presented. The braze alloy composition includes nickel, germanium, and an active metal element. The braze alloy includes germanium in an amount greater than about 5 weight percent, and the active metal element in an amount less than about 10 weight percent. A method for sealing a ceramic component to a metal component in an electrochemical cell and, an electrochemical cell sealed thereby, are also provided.

### TECHNICAL FIELD

This invention generally relates to a braze composition. In some specific embodiments, the invention relates to a braze composition that provides corrosion-resistant sealing and other benefits to high temperature rechargeable batteries.

### BACKGROUND OF THE INVENTION

Many types of seal materials have been considered for use in high-temperature rechargeable batteries/cells for joining different components. Sodium/sulfur or sodium/metal halide cells generally include several ceramic and metal components. The ceramic components include an electrically insulating alpha-alumina collar and an ion-conductive electrolyte beta-alumina tube, and are generally joined or bonded via a sealing glass. The metal components include a metallic casing, current collector components, and other metallic components which are often joined by welding or thermal compression bonding (TCB). However, metal-to-ceramic bonding has several issues, mainly due to thermal stress caused by a mismatch in the coefficient of thermal expansion for the ceramic and metal components.

The metal-to ceramic bonding is most critical for the reliability and safety of the cell. Many types of seal materials and sealing processes have been considered for joining metal to ceramic components, including ceramic adhesives, brazing, and sintering. However, most of the seals may not withstand high temperatures and corrosive environments.

A common bonding technique involves multiple steps of metalizing the ceramic component, followed by bonding the metallized ceramic component to the metal component using TCB. The bond strength of such metal-to-ceramic joints is controlled by a wide range of variables, for example the microstructure of the ceramic component, the metallization of the ceramic component, and various TCB process parameters. In order to ensure good bond strength, the process requires close control of several parameters involved in various process steps. In short, the method is relatively expensive, and complicated, in view of the multiple processing steps, and the difficulty in controlling the processing steps.

Brazing is another potential technique for making the ceramic-to-metal joints. A braze material is heated above its melting point, and distributed between two or more close-fitting parts by capillary action. However, most of the brazing materials for braze materials) have limitations that prevent them from fulfilling all of the necessary requirements of high temperature batteries. Moreover, some of the commercial braze materials can be quite expensive.

It may be desirable to develop new braze alloy compositions that have properties and characteristics so as to meet performance requirements for high temperature rechargeable batteries. It is also desirable to provide more efficient and less complicated methods for sealing the batteries, as compared to some of the existing sealing methods.

### BRIEF DESCRIPTION

Various embodiments of the present invention may provide braze alloy compositions for sealing a ceramic to a metal, to form a seal that can withstand corrosive environments.

In accordance with an embodiment of the invention, a braze alloy composition is disclosed, comprising nickel, germanium, and an active metal element. The braze alloy includes germanium in an amount greater than about 5 weight percent, and the active metal element in an amount less than about 10 weight percent.

In one embodiment, an electrochemical cell incorporating the braze alloy composition is disclosed. The braze alloy includes an active metal element that forms a ceramic-to-metal joint, and has good sodium- and halide-resistance at operating temperatures, along with other complimentary mechanical properties; stability at high temperatures; and good thermal expansion properties, and the like. In one embodiment, an energy storage device is also disclosed.

In one embodiment, a method for brazing a ceramic component to a metal component is disclosed. The method includes a step of introducing a braze alloy between a first component and a second component to be joined, to form a brazing structure, and heating the brazing structure to form an active braze seal.

### BRIEF DESCRIPTION OF DRAWINGS

These and other features, aspects, and advantages of the present invention will become better understood when the following detailed description is read with reference to the accompanying drawings, wherein:

FIG. 1 is a schematic view showing a cross-section of an electrochemical cell, according to an embodiment; and

FIG. 2 is a scanning electron micrograph showing an interface between a ceramic and a braze alloy.

### DETAILED DESCRIPTION

The invention includes embodiments that relate to a braze alloy composition for sealing an electrochemical cell, for example a sodium/sulfur or a sodium metal halide battery. The invention also includes embodiments that relate to a method of scaling an electrochemical cell and an electrochemical cell made by using the braze composition. As discussed in detail below, some of the embodiments of the present invention provide a braze alloy for sealing a ceramic component to a metal component, and a method for the same, for a metal halide battery. These embodiments advantageously provide an improved seal and method for the sealing. Though the present discussion provides examples in the context of a metal halide battery, these processes can be applied to any other application, including ceramic-to-metal or ceramic-to-ceramic joining.

When introducing elements of various embodiments of the present invention, the articles “a,” “an,” “the,” and “said” are intended to mean that there are one or more of the elements, unless otherwise indicated. The terms “comprising,” “including,” and “having” are intended to be inclusive, and mean that there may be additional elements other than the listed elements. As used herein, the term “and/or” includes any and all combinations of one or more of the associated listed items. Unless otherwise indicated herein, the terms “disposed on”, “deposited on” or “disposed between” refer to both direct contact between layers, objects, and the like, or indirect contact, e.g., having intervening layers therebetween.

Approximating language, as used herein throughout the specification and claims, may be applied to modify any quantitative representation that could permissibly vary without resulting in a change in the basic function to which it may be related. Accordingly, a value modified by a term such as “about” is not limited to the precise value specified. In some instances, the approximating language may correspond to the precision of an instrument for measuring the value.

As used herein, the term “liquidus temperature” generally refers to a temperature at which an alloy is transformed from a solid into a molten or viscous state. The liquidus temperature specifies the maximum temperature at which crystals can co-exist with the melt in thermodynamic equilibrium. Above the liquidus temperature, the alloy is homogeneous, and below the liquidus temperature, more and more crystals begin to form in the melt with time, depending on the alloy. Generally, an alloy, at its liquidus temperature, melts and forms a seal between two components to be joined.

The liquidus temperature can be contrasted with a “solidus temperature”. The solidus temperature quantifies the point at which a material completely solidifies (crystallizes). The liquidus and solidus temperatures do not necessarily align or overlap. If a gap exists between the liquidus and solidus temperatures, then within that gap, the material consists of solid and liquid phases simultaneously (like a “slurry”).

“Sealing” is a function performed by a structure that joins other structures together, to reduce or prevent leakage through the joint, between the other structures. The seal structure may also be referred to as a “seal.”

Typically, “brazing” uses a braze material (usually an alloy) having a lower liquidus temperature than the melting points of the components (i.e. their materials) to be joined. The braze material is brought slightly above its melting (or liquidus) temperature while protected by a suitable atmosphere. The braze material then flows over the components (known as wetting), and is then cooled to join the components together. As used herein, “braze alloy composition” or “braze alloy”, “braze material” or “brazing alloy”, refers to a composition that has the ability to wet the components to be joined, and to seal them. A braze alloy, for a particular application, should withstand the service conditions required, and melts at a lower temperature than the base materials; or melts at a very specific temperature. Conventional braze alloys usually do not wet ceramic surfaces sufficiently to form a strong bond at the interface of a joint. In addition, the alloys may be prone to sodium and halide corrosion.

As used herein, the term “brazing temperature” refers to a temperature to which a brazing structure is heated to enable a braze alloy to wet the components to be joined, and to form a braze joint or seal. The brazing temperature is often higher than or equal to the liquidus temperature of the braze alloy. In addition, the brazing temperature should be lower than the temperature at which the components to be joined may not remain chemically, compositionally, and mechanically stable. There may be several other factors that influence the brazing temperature selection, as those skilled in the art understand.

Embodiments of the present invention provide a braze alloy composition capable of forming a joint by “active brazing” (described below). In some specific embodiments, the composition also has high resistance to sodium and halide corrosion. The braze alloy composition includes nickel, germanium, and an active metal element, as described herein. Each of the elements of the alloy contributes to at least one property of the overall braze composition, such as liquidus temperature, coefficient of thermal expansion, flowability or wettability of the braze alloy with a ceramic, and corrosion resistance. Some of the properties are described below.

According to most of the embodiments of the invention, the braze alloy composition is based on a nickel-germanium (Ni—Ge) binary alloy. Nickel is a base metal for the braze alloy, which is relatively inert in corrosive environments, as compared to other known base metals, e.g. copper, iron, chromium, etc. Germanium is a melting point depressant, the addition of which reduces the melting point of the overall composition. As used herein, the term “melting point depressant” refers to an element which may depress the melting point of the resulting alloy, when added to another element or an alloy. The melting point depressant element may decrease the viscosity and, in turn, increase the flowability (also referred to as wettability) of the braze alloy, at an elevated temperature.

Generally, Ni—Ge binary alloys exhibit good strength, ductility, and good phase stability at high temperatures. The presence of germanium in the braze alloy may influence the liquidus temperature, and phase stability of the alloy. As a eutectic composition, the Ni—Ge binary alloy tends to be brittle. In one embodiment, hypo-eutectic compositions of the Ni—Ge binary alloy may be desirable. Hypo-eutectic compositions of Ni—Ge binary alloys are compositions containing an amount of germanium less than the amount of germanium in the eutectic composition. Controlling the amount of germanium in the braze alloy provides control over the liquidus temperature, thermal expansion coefficient, and phase stability of the alloy. In some embodiments of this invention, a suitable range for the amount of germanium is less than about 50 weight percent, based on the total weight of the braze alloy. In some embodiments, germanium is present from about 10 weight percent to about 50 weight percent, based on the total weight of the braze alloy. In some specific embodiments, germanium is present from about 20 weight percent to about 40 weight percent, based on the total weight of the braze alloy.

The hypo-eutectic compositions of the Ni—Ge alloys usually have a high temperature based on their composition. In order to reduce the liquidus temperature, additional melting point depressants may be added. Suitable examples of the additional melting point depressant include, but are not limited to, silicon, palladium, boron, copper, manganese, or a combination thereof. These additional melting point depressants may further decrease the viscosity (increase the wettability) of the braze alloy.

A suitable amount of the additional melting point depressant may be less than about 20 weight percent, based on the total weight of the braze alloy (but excluding the amount of germanium). In some embodiments, the braze alloy includes up to about 15 weight percent of the additional depressants. A suitable range is often from about 1 weight percent to about 10 weight percent. In some specific embodiments, the braze alloy includes up to about 10 weight percent palladium, based on the total weight of the braze alloy. In some embodiments, the braze alloy includes up to about 10 weight percent silicon, based on the total weight of the braze alloy. In some embodiments, the braze alloy includes up to about 5 weight percent boron, based on the total weight of the braze alloy. In some embodiments, a small amount of each of silicon or boron (e.g., less than about 5 weight percent) is used, as each of these may react with the active metal element (e.g. titanium) to form high-melting alloys. (All of these ranges are calculated with the exclusion of the germanium level).

In some embodiments, the braze alloy contains only a small amount of copper (e.g., less than about 1 weight percent), or is completely free of copper. A high amount of copper may sometimes affect the sodium conduction properties through beta-alumina, and can be detrimental to cell performance. Moreover, manganese containing alloys may be susceptible to corrosion in the halide environment. In some embodiments, the braze alloy contains only a small amount of manganese (e.g. less than about 1 weight percent), or is completely free of manganese.

“Active brazing” is a brazing approach often used to join a ceramic to a metal, or a ceramic to a ceramic. Active brazing uses an active metal element that promotes wetting of a ceramic surface, enhancing the capability of providing a hermetic seal. An “active metal element”, as used herein, refers to a reactive metal that has high affinity to the oxygen within the ceramic, and thereby reacts with the ceramic. A braze alloy containing an active metal element can also be referred to as an “active braze alloy.” The active metal element undergoes a decomposition reaction with the ceramic, when the braze alloy is in molten state, and leads to the formation of a thin reaction layer on the interface of the ceramic and the braze alloy. The thin reaction layer allows the braze alloy to wet the ceramic surface, resulting in the formation of a ceramic-ceramic or a ceramic-metal joint/bond, which may also be referred to as “active braze seal.”

Thus, an active metal element is an essential constituent of a braze alloy for employing active brazing. A variety of suitable active metal elements may be used to form the active braze alloy. The selection of a suitable active metal element mainly depends on the chemical reaction with the ceramic (e.g., alumina) to form a uniform and continuous reaction layer, and the capability of the active metal element of forming an alloy with a base alloy (e.g. Ni—Ge alloy). The active metal element for embodiments herein is often titanium. Other suitable examples of the active metal element include, but are not limited to, zirconium, hafnium, and vanadium. A combination of two or more active metal elements may also be used. In some specific embodiments, the braze alloy includes titanium.

The presence and the amount of the active metal may influence the thickness and the quality of the thin reactive layer, which contributes to the wettability or flowability of the braze alloy, and therefore, the bond strength of the resulting joint. In some embodiments, the active metal is present in an amount less than about 10 weight percent, based on the total weight of the braze alloy. A suitable range is often from about 0.5 weight percent to about 5 weight percent. In some specific embodiments, the active metal is present in an amount ranging from about 1 weight percent to about 3 weight percent, based on the total weight of the braze alloy. The active metal element is generally present in small amounts suitable for improving the wetting of the ceramic surface, and forming the thin reaction layer, for example, less than about 10 microns. A high amount of the active metal layer may cause or accelerate halide corrosion.

The braze alloy composition may further at least one alloying element. The alloying element may provide further adjustments in several required properties of the braze alloy, for example coefficient of thermal expansion, liquidus temperature and brazing temperature. In one embodiment, the alloying element can include, but is not limited to, cobalt, iron, chromium, niobium or a combination thereof. In some embodiments, the braze alloy includes up to about 30 weight percent (e.g., about 1%-30%) of the alloying element, based on the total weight of the braze alloy. In some specific embodiments, the braze alloy includes up to about 10 weight percent chromium, based on the total weight of the braze alloy. In other specific embodiments, the braze alloy includes up to about 10 weight percent niobium, based on the total weight of the braze alloy. In some embodiments, the braze alloy includes up to about 20 weight percent of iron, based on the total weight of the braze alloy. In some specific embodiments, the braze alloy includes up to about 30 weight percent of cobalt, based on the total weight of the braze alloy.

As discussed above, the braze alloy has a liquidus temperature lower than the melting temperatures of the components to be joined. In one embodiment, the braze alloy has a liquidus temperature of at least about 850 degrees Celsius. In one embodiment, the braze alloy has a liquidus temperature from about 850 degrees Celsius to about 1300 degrees Celsius, and in some specific embodiments, from about 950 degrees Celsius to about 1250 degrees Celsius.

Some embodiments provide an electrochemical cell that comprises a first component and a second component joined to each other by a braze alloy composition. The cell may be a sodium-sulfur cell or a sodium-metal halide cell, for example. As described previously, the braze alloy composition includes nickel, germanium, and an active metal element. At least one additional melting point depressant, such as silicon, palladium, copper, and/or manganese, may further be added. The constituents of the alloy and their respective amounts are described above.

As discussed above, the braze alloy composition may provide an active braze seal to join components in the cell. In one embodiment, the first component of the cell comprises a metal, and the second component comprises a ceramic. The metal component can be a ring that includes nickel. The ceramic component can be a collar that includes an electrically insulating material, such as alpha-alumina.

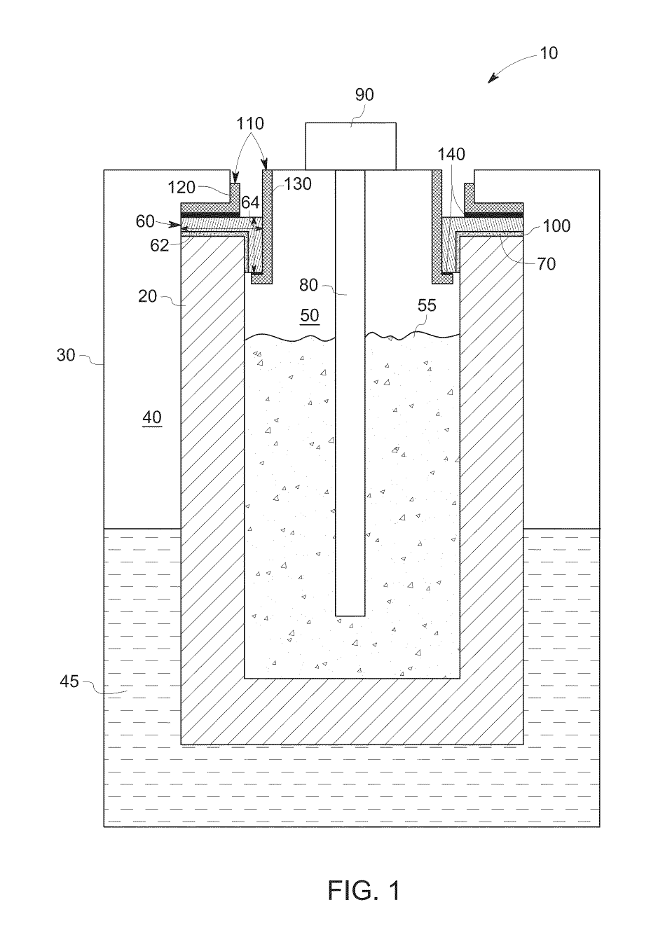

For example, sodium-sulfur or sodium-metal halide cells may contain the braze alloy composition that forms an active braze seal to form metal-to-ceramic joints. The active braze seal secures an alpha-alumina collar and a nickel ring. FIG. 1 is a schematic diagram depicting an exemplary embodiment of a sodium-metal halide battery cell 10. The cell 10 has an ion-conductive separator tube 20 disposed in a cell case 30. The separator tube 20 is usually made of β-alumina or β″-alumina. The tube 20 defines an anodic chamber 40 between the cell case 30 and the tube 20, and a cathodic chamber 50, inside the tube 30. The anodic chamber 40 is usually filled with an anodic material 45, e.g. sodium. The cathodic chamber 50 contains a cathode material 55 (e.g. nickel and sodium chloride), and a molten electrolyte, usually sodium chloroaluminate (NaAlCl₄).

An electrically insulating ceramic collar 60, which may be made of alpha-alumina, is situated at a top end 70 of the tube 20. A cathode current collector assembly 80 is disposed in the cathode chamber 50, with a cap structure 90, in the top region of the cell. The ceramic collar 60 is fitted onto the top end 70 of the separator tube 20, and is sealed by a glass seal 100. In one embodiment, the collar 60 includes an upper portion 62, and a lower inner portion 64 that abuts against an inner wall of the tube 20, as illustrated in FIG. 1.

In order to seal the cell 10 at the top end (i.e., its upper region), and protect the alumina collar 60 in the corrosive environment, a metal ring 110 is disposed, covering the alpha alumina collar 60, and joining the collar with the current collector assembly 80, at the cap structure 90. The metal ring 110 has two portions; an outer metal ring 120 and an inner metal ring 130, which are joined, respectively, with the upper portion 62 and the lower portion 64 of the ceramic collar 60, by means of the active braze seal 140. The active braze seal 140 is provided by the braze alloy composition described above. The collar 60 and the metal ring 110 may be temporarily held together with an assembly (e.g., a clamp), or by other techniques, until sealing is complete.

The outer metal ring 120 and the inner metal ring 130 are usually welded shut to seal the cell, after joining with the ceramic collar 60 is completed. The outer metal ring 120 can be welded to the cell case 30; and the inner metal ring 130 can be welded to the current collector assembly 80.

The shapes and size of the several components discussed above with reference to FIG. 1 are only illustrative for the understanding of the cell structure; and are not meant to limit the scope of the invention. The exact position of the seals and the joined components can vary to some degree. Moreover, each of the terms “collar” and “ring” is meant to comprise metal or ceramic parts of circular or polygonal shape, and in general, all shapes that are compatible with a particular cell design.

The braze alloys and the active braze seal formed thereof, generally have good stability and chemical resistance within determined parameters at a determined temperature. It is desirable that the braze seal retains its integrity and properties during several processing steps while manufacturing and using the cell, for example, during a glass-seal process for a ceramic-to-ceramic joint, and during operation of the cell. In some instances, optimum performance of the cell is generally obtained at a temperature greater than about 300 degrees Celsius. In one embodiment, the operating temperature may be in a range from about 270 degrees Celsius to about 450 degrees Celsius. In one embodiment, the glass-seal process is carried out at a temperature of at least about 1000 degrees Celsius. In some other embodiments, the glass-seal process is carried out in a range of from about 1000 degrees Celsius to about 1200 degrees Celsius. Moreover, the bond strength and hermeticity of the seal may depend on several parameters, such as the composition of the braze alloy, thickness of the thin reaction layer, the composition of the ceramic, and the surface properties of the ceramic.

In accordance with some embodiments of this invention, an energy storage device includes a plurality of the electrochemical cells as disclosed in previous embodiments. The cells are, directly or indirectly, in thermal and/or electrical communication with each other. Those of ordinary skill in the art are familiar with the general principles of such devices.

Some embodiments provide a method for joining a first component to a second component by using a braze alloy composition. The method includes steps of introducing the braze alloy between the first component and the second component to form a brazing structure. (The alloy could be deposited on one or both of the mating surfaces, for example, as also described below). The brazing structure can then be heated to form an active braze seal between the first component and the second component. In one embodiment, the first component includes a ceramic and the second component includes a metal. The braze alloy composition includes nickel, germanium, and an active metal element. At least one additional melting point depressant, such as silicon, palladium, copper, and/or manganese, may further be added. The constituent of the braze alloy and their respective amounts are described above.

In the general preparation of the braze alloy, the alloy powder mixture may be prepared by combining (e.g., mixing and/or milling) commercial metal powders of the constituents in their respective amounts. In other embodiments, the braze alloy may be employed as a foil, a ribbon, a preform, or a wire, or may be formulated into a paste containing water and/or organic fluids. In some embodiments, the precursor metals or metal alloys may be melted to form homogeneous melts, before being formed and shaped into particles. In some cases, the molten material can be directly shaped into foils, preforms or wires. Forming the materials into particles, initially, may comprise spraying the alloy melt into a vacuum, or into an inert gas, to obtain a pre-alloyed powder of the braze alloy. In other cases, pellets of the materials may be milled into a desired particle shape and size.

In one embodiment, a layer of the braze alloy is disposed on at east one surface of the first component or the second component to be joined by brazing. The layer of the braze alloy, in a specific embodiment, is disposed on a surface of the ceramic component. The thickness of the alloy layer may be in a range between about 5 microns to about 100 microns. In some specific embodiments, the thickness of the layer ranges from about 10 microns to about 50 microns. The layer may be deposited or applied on one or both the surfaces to be joined, by any suitable technique, e.g. by a printing process or other dispensing processes. In some instances, the foil, wire, or the preform may be suitably positioned for bonding the surfaces to be joined.

The method further includes step of heating the brazing structure at the brazing temperature. When the brazing structure is heated at the brazing temperature, the braze alloy melts and flows over the surfaces. The heating can be undertaken in a controlled atmosphere, such as argon, hydrogen, nitrogen, helium; or in a vacuum. To achieve good flow and wetting of the braze alloy, the brazing structure is held at the brazing temperature for a few minutes after melting of the braze alloy, and this period may be referred to as “brazing time”.

The brazing temperature and the brazing time may influence the quality of the active braze seal. The brazing temperature is generally less than the melting temperatures of the components to be joined, and higher than the liquidus temperature of the braze alloy. In one embodiment, the brazing temperature ranges from about 900 degrees Celsius to about 1500 degrees Celsius for about 1 minute to about 30 minutes. In a specific embodiment, the heating is carried out a the brazing temperature from about 1000 degrees Celsius to about 1300 degrees Celsius for about 5 minutes to about 15 minutes.

During brazing, the active metal element (or elements) present in the melt decomposes, and forms a thin reactive layer at the interface of the ceramic surface and the braze alloy, as described previously. The thickness of the reactive layer may range from about 0.1 micron to about 2 microns, depending on the amount of the active metal element available to react with the ceramic, and the surface properties of the ceramic component. The brazing structure is then subsequently cooled to room temperature; with a resulting, active braze seal between the two components. In some instances, rapid cooling of the brazing structure is permitted.

Some of the embodiments of the present invention advantageously provide braze alloys, which are chemically stable in the corrosive environment relative to known braze alloys, and are capable of forming an active braze seal for a ceramic-to-metal joint. Making ceramic-to-metal seals for high temperature cells (as discussed above) by active brazing simplifies the joining process, and improves the reliability and performance of the cell. The present invention provides advantages to leverage a relatively economic, simple, and rapid process to seal the cell or battery, as compared to currently available methods.

### EXAMPLES

The examples that follow are merely illustrative, and should not be construed to be any sort of limitation on the scope of the claimed invention. Unless specified otherwise, all ingredients may be commercially available from such common chemical suppliers as Alpha Aesar, Inc. (Ward Hill, Mass.), Sigma Aldrich (St. Louis, Mo.), Spectrum Chemical Mfg. Corp. (Gardena, Calif.), and the like.

### Example 1

3 braze alloy compositions (samples 1-3) were prepared. For each braze sample, individual elements were weighed according to the desired composition, as shown in Table 1. These elements were arc-melted to provide an ingot for each composition. To ensure homogeneity of the compositions, the ingots were triple-melted. These ingots were then characterized for measuring liquidus temperatures and coefficients of thermal expansion by using Differential Scanning calorimeter (DSC), and a dilatometer, respectively. The liquidus temperatures for each sample are shown in Table 1. The measured coefficient of thermal expansion for sample 1 was about 16.4 ppm per degree Celsius, in the temperature range of about 50 degrees Celsius to about 700 degrees Celsius. The ingots were melt-spun into thin (about 25 micron thick) ribbons, in a pure argon atmosphere.

TABLE 1

| Braze | Braze alloy composition | Liquidus temperature |
|---|---|---|
| Samples | (weight percent) | (degrees Celsius) |
| Sample 1 | Ni—26Ge—3Ti | 1155 |
| Sample 2 | Ni—25Ge—10Pd—3Ti | 1105 |
| Sample 3 | Ni—25Ge—10Pd—5Si—3Ti | 1075 |

The thin ribbon (foil) of braze sample 1 was then placed between the surfaces of an alpha alumina collar and a nickel ring, to be joined. This assembly was then heated up to about 1200 degrees Celsius for about 10 minutes, and then cooled to room temperature, to form a joint between the alpha alumina collar and the nickel ring.

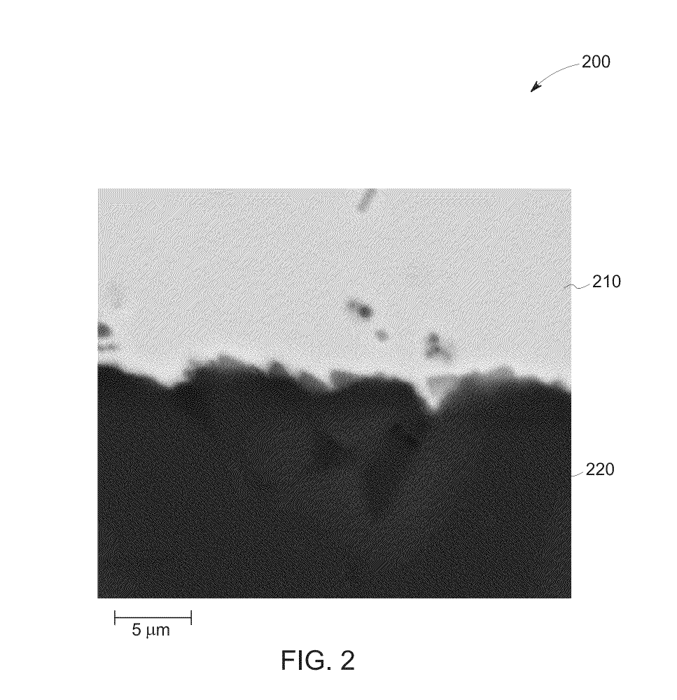

FIG. 2 shows a cross-section SEM image 200 of an interface between the alpha alumina 220 and braze sample 1, 210 at the joint. A reaction layer was observed between the braze sample 1 and the alumina collar at the braze-ceramic interface. Inspection with Energy Dispersive Analysis of X-Rays (EDAX) confirmed that the composition of the reaction layer included oxides of titanium, which would have been formed by the reaction of the titanium in braze sample 1, with alumina.

Sample 1 was tested for sodium resistance in an accelerated corrosion test. 3 pieces of sample 1 were loaded inside a capsule with two sodium cubes (99.99%, Sigma-Aldrich). The capsule was designed using Swagelok® parts made of stainless steel, SS316, with VCR® fittings. To ensure a leak proof capsule, a gasket made of stainless steel, SS316L, was used. The capsule was loaded inside a nitrogen-filled glove box (moisture<0.1 ppm and oxygen<0.1 ppm). The capsule was loaded in a furnace and heated up to about 350° C., to melt the sodium pieces. The pieces of sample 1 were completely immersed in the molten sodium for about 4 weeks, during testing.

Sample 1 was tested for resistance to halide-melt at 350° C., for about 4 weeks. A capsule was designed using Swagelok® parts made of stainless steel, SS304, with compression fitting. An alumina lining was used to contain the halide powder. The composition of the halide melt was NaAlCl₄. The capsule was loaded inside a nitrogen-filled glove box (moisture<0.1 ppm and oxygen<0.1 ppm). A piece of the sample 1 was loaded inside the capsule. The piece was completely immersed in the molten halide during testing.

The pieces were examined for physical and chemical integrity (percentage weight change), and for resistance to sodium- and halide-corrosion. It was observed that the pieces of the sample 1 showed no cracking or loss of shape (i.e., they were physically stable), and showed no weight change, or minimal weight change. Thus, it was clear that sample 1 showed substantially no corrosion, or minimum corrosion to sodium, as well as halide.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A braze alloy composition, comprising nickel, germanium, and an active metal element, wherein germanium is present in an amount greater than about 5 weight percent, and the active metal element is present in an amount less than about 10 weight percent.

2. The braze alloy composition of claim 1, comprising from about 5 weight percent to about 50 weight percent germanium.

3. The braze alloy composition of claim 2, comprising from about 10 weight percent to about 40 weight percent germanium.

4. The braze alloy composition of claim 1, comprising from about 0.5 weight percent to about 5 weight percent of the active metal element.

5. The braze alloy composition of claim 4, comprising from about 1 weight percent to about 3 weight percent of the active metal element.

6. The braze alloy composition of claim 1, wherein the active metal element comprises titanium, zirconium, hafnium, vanadium, or a combination thereof.

7. The braze alloy composition of claim 1, wherein the active metal element comprises titanium.

8. The braze alloy composition of claim 1, further comprising a melting point-depressant.

9. The braze alloy composition of claim 8, wherein the melting point depressant comprises silicon, palladium, boron, copper, manganese or a combination thereof.

10. The braze alloy composition of claim 8, wherein the melting point depressant is present in an amount ranging from about 1 weight percent to about 20 weight percent.

11. The braze alloy composition of claim 1, further comprising an alloying element in an amount less than about 30 weight percent, based on the total weight of the braze alloy composition.

12. The braze alloy composition of claim 11, wherein the alloying element comprises cobalt, iron, chromium, niobium or a combination thereof.

13. The braze alloy composition of claim 1, having a liquidus temperature of at least about 850 degrees Celsius.

14. The braze alloy composition of claim 13, having a liquidus temperature in a range from about 850 degrees Celsius to about 1250 degrees Celsius.

15. An electrochemical cell, comprising a first component and a second component joined to each other by the braze alloy composition as defined in claim 1.

16. The electrochemical cell of claim 15, wherein the braze alloy composition provides an active braze seal that joins the first component to the second component.

17. The electrochemical cell of claim 15, wherein the first component comprises a metal, and the second component comprises a ceramic.

18. The electrochemical cell of claim 15, wherein the first component comprises nickel.

19. The electrochemical cell of claim 15, wherein the second component comprises alumina.

20. An energy storage device comprising a plurality of electrochemical cells as defined in claim 15.

21. A method, comprising:
introducing a braze alloy composition between first component and a second component to be joined to form a brazing structure, wherein the braze alloy composition comprises nickel, germanium, and an active metal element, wherein the germanium is present in an amount greater than about 5 weight percent, and the active metal element is present in an amount less than about 10 weight percent, and heating the brazing structure to form an active braze seal (joint) between the first component and the second component.

22. The method of claim 21, wherein introducing a braze alloy composition comprises forming a layer of the braze alloy composition on at least a surface of the first component, or a surface of the second component.

23. The method of claim 21, wherein introducing a braze alloy composition comprises placing a foil, a ribbon, a wire, or a preform of the braze alloy composition between the first component and the second component.

24. The method of claim 21, wherein heating is carried out at a brazing temperature.

25. The method of claim 24, wherein heating is carried out in a temperature range from about 900 degrees Celsius to about 1300 degrees Celsius, for less than about 30 minutes.
